(19) United States
(12) Patent Application Publication
(10) Pub. No.: US 2025/0085762 A1
(43) Pub. Date: Mar. 13, 2025

(54) BLOCK GENERATION METHOD, BLOCK GENERATION DEVICE, AND RECORDING MEDIUM

(71) Applicant: Panasonic Intellectual Property Corporation of America, Torrance, CA (US)

(72) Inventors: Ayaka NAKASAKA, Osaka (JP); Junji MICHIYAMA, Fukuoka (JP); Yuji UNAGAMI, Osaka (JP); Kakuya YAMAMOTO, Hyogo (JP); Motoji OHMORI, Osaka (JP)

(21) Appl. No.: 18/955,241

(22) Filed: Nov. 21, 2024

Related U.S. Application Data
(63) Continuation of application No. PCT/JP2023/017377, filed on May 9, 2023.
(60) Provisional application No. 63/350,554, filed on Jun. 9, 2022.

(51) Int. Cl. G06F 1/3234; H04L 9/00

(52) U.S. Cl. CPC G06F 1/3234; H04L 9/50

(57) ABSTRACT

A block generation method is performed by a block generation device that generates a block in a blockchain and includes: obtaining transaction data including a power-saving request to save power required for a generation process related to generation of the block by the block generation device; and executing the generation process by consuming an amount of power that meets the power-saving request.

### CROSS REFERENCE TO RELATED APPLICATIONS

This is a continuation application of PCT International Application No. PCT/JP2023/017377 filed on May 9, 2023, designating the United States of America, which is based on and claims priority of U.S. Provisional Patent Application No. 63/350,554 filed on Jun. 9, 2022. The entire disclosures of the above-identified applications, including the specifications, drawings and claims are incorporated herein by reference in their entirety.

### FIELD

The present disclosure relates to block generation methods, block generation devices, and recording media.

### BACKGROUND

Patent Literature (PTL) 1 discloses a technique that uses a proof of work (PoW) to generate a block in a blockchain.

### CITATION LIST

### Patent Literature

PTL 1: Japanese Unexamined Patent Application Publication (Translation of PCT application) No. 2022-546773

### SUMMARY

### Technical Problem

An object of the present disclosure is to provide a block generation method, etc., in which the amount of power consumption required for the process of adding a block to a blockchain can be adjusted in response to a power-saving request.

### Solution to Problem

A block generation method according to one aspect of the present disclosure is performed by a block generation device that generates a block in a blockchain and includes: obtaining transaction data including a power-saving request to save power required for a generation process related to generation of the block by the block generation device; and executing the generation process by consuming an amount of power that meets the power-saving request.

Note that these general and specific aspects may be implemented using a system, a device, an integrated circuit, a computer program, or a computer-readable recording medium such as a compact disc read-only memory (CD-ROM), or any combination of systems, devices, integrated circuits, computer programs, and recording media.

### Advantageous Effects

According to the present disclosure, the amount of power consumption required for the process of adding a block to a blockchain can be adjusted in response to a power-saving request.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram illustrating one example of the configuration of a management system according to Embodiment 1.

FIG. 2 is a diagram illustrating one example of the configuration of a block generation device according to Embodiment 1.

FIG. 3 is a sequence chart for describing one example of a generation process executed in response to a power-saving request, in a management system according to Embodiment 1.

FIG. 4 is a sequence chart for describing one example of a generation process executed in response to a power-saving request, in a management system according to a variation of Embodiment 1.

FIG. 5 is a diagram illustrating one example of the configuration of a block generation device according to Embodiment 2.

FIG. 6 is a table illustrating one example of difficulty level information.

FIG. 7 is a sequence chart for describing one example of a generation process executed in response to a power-saving request, in a management system according to Embodiment 2.

FIG. 8 is a diagram illustrating one example of the configuration of a management system according to another embodiment.

FIG. 9 is an explanatory diagram illustrating the data structure of a blockchain.

FIG. 10 is an explanatory diagram illustrating the data structure of transaction data.

### DESCRIPTION OF EMBODIMENTS

### Underlying Knowledge Forming Basis of the Present Disclosure

An enormous amount of power is consumed in the process of adding a block to a blockchain for trading non-fungible tokens (NFTs). When a block is generated using POW disclosed in PTL 1, the total amount of power consumption is expected to increase. This is because the number of participating nodes increases and according to the increase in the participating nodes, the computational effort in a validation process increases in addition to the total amount of computing resources.

Furthermore, even when a block is generated using proof of stake (PoS), in which environmental burdens are taken into consideration, an enormous amount of power consumption is required to trade non-fungible tokens (NFTs) and moreover, there is no system that temporarily reduces the amount of power consumption of the entire network of the blockchain system.

The inventors found the need of a system that reduces the amount of power consumption of the entire network of the blockchain system in response to a power-saving request from a management entity for the blockchain system such as a power company or a mining company. In other words, the inventors found a block generation method, etc., in which the amount of power consumption required for the process of adding a block to a blockchain can be adjusted in response to a power-saving request as indicated below.

A block generation method according to the first aspect of the present disclosure is performed by a block generation device that generates a block in a blockchain and includes: obtaining transaction data including a power-saving request to save power required for a generation process related to generation of the block by the block generation device; and executing the generation process by consuming an amount of power that meets the power-saving request.

Therefore, the generation process can be executed so as to meet the power-saving request. Thus, the amount of power consumption of the entire blockchain system can be reduced.

A block generation method according to the second aspect of the present disclosure is the block generation method according to the first aspect that further includes: determining whether the block generation device holds a first right to add a new block to the blockchain. The generation process starts when the block generation device is determined as holding the first right.

Therefore, it is possible to reduce the amount of power consumption of the block generation device that holds the first right to add a new block to the blockchain.

A block generation method according to the third aspect of the present disclosure is the block generation method according to the second aspect in which the generation process starts when the generation process is executable by consuming the amount of power.

Therefore, a block generation device capable of executing the generation process by consuming an amount of power that meets the power-saving request can add a new block to the blockchain. Thus, the block generation device capable of reducing power consumption executes the generation process and therefore, the amount of power consumption of the entire blockchain system can be effectively reduced.

A block generation method according to the fourth aspect of the present disclosure is the block generation method according to the third aspect in which the determining further includes: (i) calculating, based on the power-saving request, a target value of an amount of power consumption required for the generation process and an expected amount of power consumption which is an amount of power consumption expected to be required for the generation process; and (ii) when the expected amount of power consumption is less than or equal to the target value, determining that the generation process is executable by consuming the amount of power.

Therefore, a block generation device capable of setting the expected amount of power consumption, which is an amount of power consumption expected to be required for the generation process, to less than or equal to the target value of power consumption can add a new block to the blockchain. Thus, the block generation device capable of reducing power consumption executes the generation process and therefore, the amount of power consumption of the entire blockchain system can be effectively reduced.

A block generation method according to the fifth aspect of the present disclosure is the block generation method according to any one of the second to fourth aspects in which the determining further includes: when the generation process is executable by consuming the amount of power, determining whether the block generation device holds a second right to add a new block to the blockchain, and the generation process starts when the block generation device is determined as holding the first right and the second right and the generation process is executable by consuming the amount of power.

Therefore, it is possible to reduce the amount of power consumption of the block generation device that further holds the second right to add a new block to the blockchain.

A block generation method according to the sixth aspect of the present disclosure is the block generation method according to the fifth aspect in which the block generation device that holds the second right is determined at random from among one or more block generation devices each holding the first right and capable of executing the generation process by consuming the amount of power.

Therefore, when there are one or more block generation devices capable of executing the generation process by consuming an amount of power that meets the power-saving request, a block generation device capable of adding a new block to the blockchain can be determined.

A block generation method according to the seventh aspect of the present disclosure is the block generation method according to the first aspect that further includes: adjusting a level of difficulty of mining based on the power-saving request. The generation process is executed based on the level of difficulty of mining that has been adjusted.

As the level of difficulty of mining is reduced, processing load required for mining is reduced and thus, the amount of power consumption required for mining is also reduced. Therefore, the amount of power consumption required for the generation process can be adjusted by adjusting the level of difficulty of mining in response to the power-saving request.

A block generation method according to the eighth aspect of the present disclosure is the block generation method according to the seventh aspect in which the transaction data further includes difficulty level information indicating a relationship between the power-saving request and the level of difficulty of mining, and in the adjusting, the level of difficulty of mining is adjusted based on the power-saving request and the difficulty level information.

Therefore, the level of difficulty of mining corresponding to the power-saving request can be properly determined on the basis of the difficulty level information and thus, the amount of power consumption required for the generation process can be reduced in response to the power-saving request.

A block generation method according to the ninth aspect of the present disclosure is the block generation method according to the eighth aspect in which in the adjusting, the level of difficulty is adjusted to be reduced with an increase in an amount of deficiency of power supply to a region in which the block generation device is located.

Therefore, the amount of power consumption of the block generation device can be reduced according to the amount of deficiency of power supply to a region in which said block generation device is located.

A block generation method according to the tenth aspect of the present disclosure is the block generation method according to the eighth or ninth aspect in which the difficult level information indicates a drop in the level of difficulty of mining when power supply to a region in which the block generation device is located is deficient, and indicates a rise in the level of difficulty of mining when the power supply is not deficient.

Therefore, the amount of power consumption of the block generation device can be adjusted according to whether there is a deficiency of power supply to a region in which said block generation device is located.

A block generation device according to the eleventh aspect of the present disclosure is a block generation device that generates a block in a blockchain and includes: an obtainer that obtains transaction data including a power-saving request to save power required for a generation process related to generation of the block by the block generation device; and a block generator that executes the generation process by consuming an amount of power that meets the power-saving request.

Therefore, the generation process can be executed so as to meet the power-saving request. Thus, the amount of power consumption of the entire blockchain system can be reduced.

A recording medium according to the twelfth aspect of the present disclosure is a non-transitory computer-readable recording medium having recorded thereon a program for causing a computer to perform the block generation method according to any one of the first to tenth aspects.

Note that these general and specific aspects may be implemented using a system, a device, an integrated circuit, a computer program, or a computer-readable recording medium such as a CD-ROM, or any combination of systems, devices, integrated circuits, computer programs, and recording media.

Hereinafter, embodiments will be described with reference to the drawings. Note that each of the embodiments described below shows one specific example of the present disclosure. The numerical values, shapes, materials, structural elements, the arrangement and connection of the structural elements, steps, the processing order of the steps, etc., shown in the following embodiments are mere examples, and are not intended to limit the present disclosure. Among the structural elements in the following embodiments, structural elements not recited in any one of the independent claims which indicate the broadest concepts are not necessarily required to achieve the object of the present disclosure, but are described as structural elements included in a more preferred embodiment.

### Embodiment 1

First, the configuration of a system according to the present disclosure will be described.

A management system according to the present disclosure includes a plurality of nodes and manages a first blockchain on a first distributed ledger of each node. Hereinafter, the configuration, etc., of the management system according to the present embodiment will be described with reference to the drawings.

### Management System

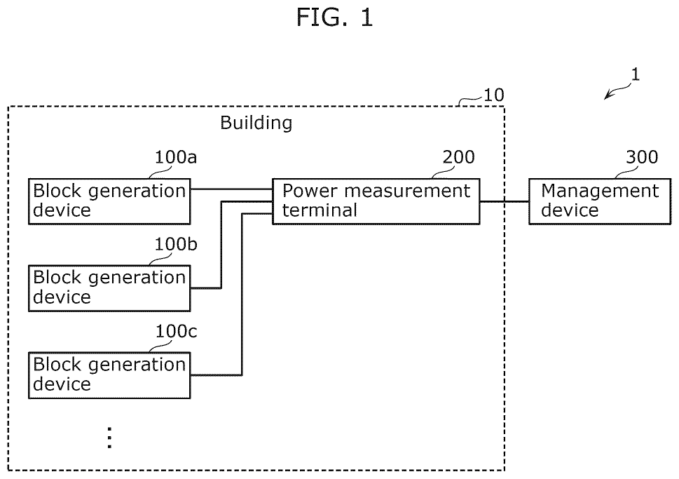

FIG. 1 is a diagram illustrating one example of the configuration of the management system according to Embodiment 1.

Management system 1 according to the present embodiment includes block generation devices 100a to 100c, power measurement terminal 200, and management device 300, for example, as illustrated in FIG. 1. Management system 1 is a computer system for managing the amount of power consumption of block generation devices 100a to 100c that is required for the process of generating blocks and adding the generated blocks to a blockchain.

Block generation devices 100a to 100c, power measurement terminal 200, and management device 300 may all be connected to each other via a network or may all be directly connected so as to allow communication therebetween, or some of block generation devices 100a to 100c, power measurement terminal 200, and management device 300 may be connected via a network while some other thereof are directly connected so as to allow communication therebetween. The network, which is the Internet or a cell-phone carrier network, for example, may include any communication line or network.

Block generation devices 100a to 100c are a group of nodes included in a blockchain network constructed using a distributed database technique. The blockchain network formed of block generation devices 100a to 100c may be any one of a public blockchain network, a private blockchain network, and a consortium blockchain network.

Note that in the following description, each of block generation devices 100a to 100c is also referred to as block generation device 100, but there are cases where block generation devices 100a to 100c are referred to as block generation devices A to C.

Block generation devices 100a to 100c and power measurement terminal 200 are included in same building 10, and power measurement terminal 200 measures the amount of power consumption of each of block generation devices 100a to 100c in building 10. Note that it is sufficient that power measurement terminal 200 be connected to block generation devices 100a to 100c so as to be able to measure the amounts of power consumption of block generation devices 100a to 100c, and power measurement terminal 200 does not need to be included in same building 10.

Management device 300, which is included in a management entity for blockchain systems such as a power company or a mining company, transmits, to power measurement terminal 200, a power-saving request for adjusting the amount of power consumption inside building 10 according to the amount of power (that is, the amount of power supply) generated at a facility of said power company. Specifically, when determining that the amount of power supply is less than the expected amount of power consumption, management device 300 transmits, to power measurement terminal 200 of each building 10, a power-saving request that requests reduced power consumption, thereby inhibiting the amount of power supply from becoming deficient for the amount of power consumption. Thus, in accordance with the change in the power demand inside building 10, management device 300 adjusts the amount of power consumption inside building 10 and thereby performs a demand response operation to strike a balance between power demand and supply.

Block generation device 100 will be described below.

### Block Generation Device

Block generation device 100 is one of block generation devices 100a to 100c. Among block generation devices 100a to 100c, block generation devices different from said one block generation device 100 are referred to as other block generation devices 100. The present embodiment assumes that there are two or more other block generation devices 100. Therefore, in the following description, sentences including the simple term “other block generation devices 100” suggest that other block generation devices 100 are two or more block generation devices 100. Note that other block generation devices 100 are not limited to two or more block generation devices and may be a single block generation device.

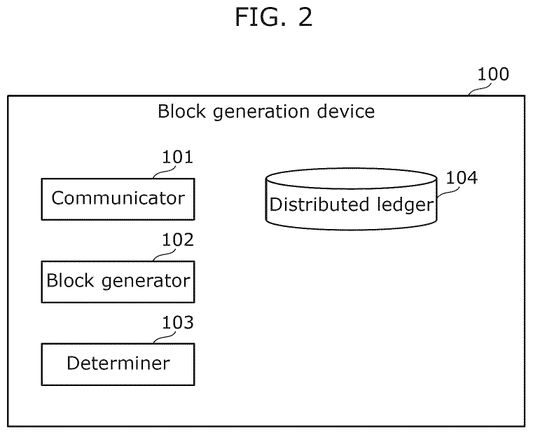

FIG. 2 is a diagram illustrating one example of the configuration of the block generation device according to Embodiment 1.

Block generation device 100 has the function of generating a block in a blockchain. As illustrated in FIG. 2, block generation device 100 includes communicator 101, block generator 102, determiner 103, and distributed ledger 104. Block generation device 100 can be implemented by a processor executing a predetermined program using a memory. The structural elements will be described below.

Communicator 101 transfers data to and from power measurement terminal 200. For example, communicator 101 transmits, to power measurement terminal 200, the amount of power received by block generation device 100. Furthermore, communicator 101 obtains, from power measurement terminal 200, transaction data including a power-saving request to save power required for a generation process related to generation of a block by block generation device 100. Moreover, communicator 101 transmits, to power measurement terminal 200, the amount of power consumption of block generation device 100.

Furthermore, communicator 101 may transfer data to and from other block generation devices 100. For example, communicator 101 transmits and receives one or more items of transaction data to and from other block generation devices 100 according to a consensus algorithm. Moreover, communicator 101 may transfer data to and from a device (terminal) different from power measurement terminal 200 and other block generation devices 100.

In this manner, communicator 101 performs communication with power measurement terminal 200 and other block generation devices 100. Note that this communication may be performed using transport layer security (TLS) and a cryptographic key for TLS communication may be held in communicator 101.

Note that communicator 101 is one example of the obtainer.

Block generator 102 executes a generation process related to generation of a block in a blockchain. When communicator 101 receives a power-saving request, block generator 102 attempts to execute the generation process by consuming the amount of power that meets the power-saving request.

Specifically, block generator 102 executes the generation process using PoS. The generation process is, for example, the entire process from generating a block in a blockchain to adding the block to the blockchain or a part of said process. According to PoS, a node that generates the next block (a new block) (a validator node) is selected on the basis of voting power in a blockchain network. For example, a node that owns more tokens (staking tokens) has more voting power and obtains more opportunities to generate blocks. This ensures the security of the blockchain and makes the process of generating a block efficient. The validator node verifies and validates transaction data, then generates a block, and adds the generated block to the blockchain. The generation process that is executed by block generator 102 starts after execution of the generation process is permitted as a result of determination by determiner 103.

Determiner 103 determines whether block generation device 100 holds a first right to add a new block to the blockchain. The first right is, for example, a right that allows block generation device 100 to become a validator node. Specifically, the first right is granted to block generation device 100 that holds a predetermined amount of tokens (staking tokens), upgrading block generation device 100 to a validator node. In other words, when block generation device 100 transmits at least the predetermined amount of tokens to a predetermined smart contract, block generation device 100 can be upgraded to a validator node. The validator node is authorized by lot to generate and validate a block in exchange for an obligation to generate the block. Since the validator node is obligated to generate the block, the validator node will be subject to penalty for failure to generate the block.

Furthermore, determiner 103 determines whether block generation device 100 is capable of executing the generation process by consuming an amount of power that meets the power-saving request. Specifically, determiner 103 (i) calculates, based on the power-saving request, a target value of power consumption required for the generation process and an expected amount of power consumption which is an amount of power consumption expected to be required for the generation process, and (ii) when the expected amount of power consumption is less than or equal to said target value, determines that the generation process is executable by consuming an amount of power that meets the power-saving request. Moreover, when the generation process is executable by consuming an amount of power that meets the power-saving request, determiner 103 further determines whether block generation device 100 holds a second right to add a new block to the blockchain. Block generation device 100 that holds the second right is determined at random from among one or more block generation devices 100 each holding the first right and capable of executing the generation process by consuming an amount of power that meets the power-saving request. At this time, a predetermined number of block generation devices 100 may be determined as block generation devices 100 that hold the second right. The predetermined number is, for example, less than the total number of block generation devices 100 included in the blockchain system.

The blockchain is stored on distributed ledger 104.

### Operation of Management System, Etc.

Next, the operation of the management system configured as described above will be described.

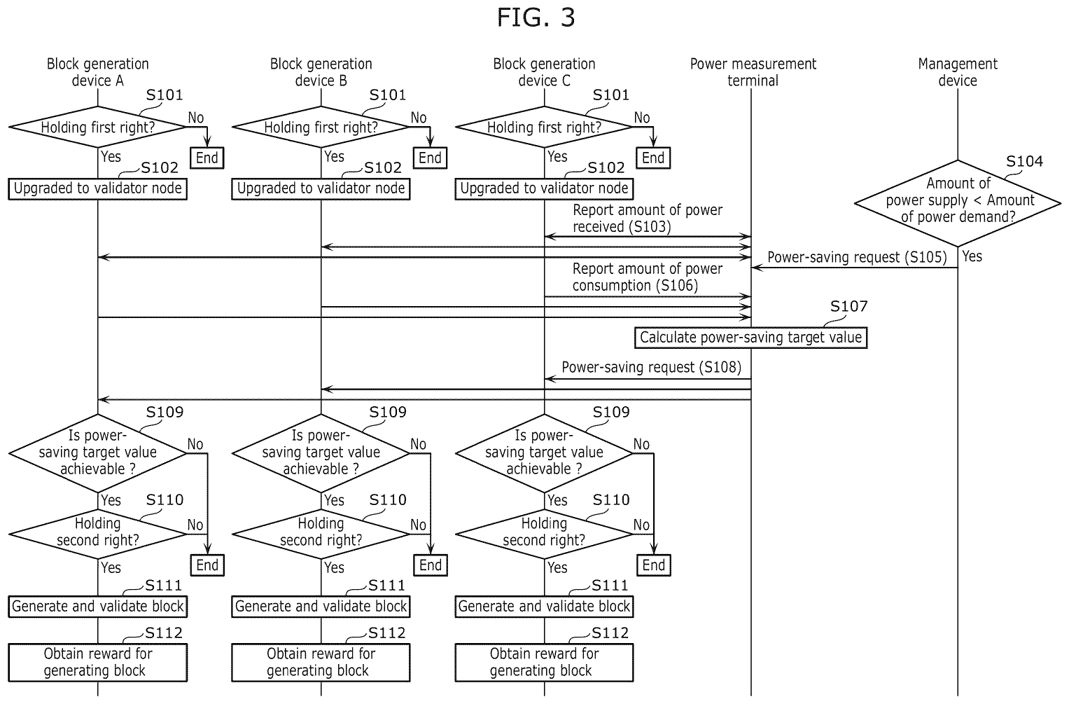

FIG. 3 is a sequence chart for describing one example of the generation process executed in response to the power-saving request, in the management system according to Embodiment 1.

Block generation device A determines whether block generation device A holds the first right (S101).

Next, when determining that block generation device A holds the first right (Yes in S101), block generation device A is upgraded to a validator node (S102). When determining that block generation device A does not hold the first right (No in S101), block generation device A ends the generation process because of not holding the right to generate a block.

Similar to block generation device A, each of block generation device B and block generation device C also performs Steps S101, S102. The following description assumes that block generation devices A to C hold the first right.

Each of block generation devices A to C establishes communication with power measurement terminal 200, and reports, to power measurement terminal 200, the amount of power received by the block generation device (S103). The amount of power received is the amount of power being currently used (that is, the amount of power consumption) by each of block generation devices A to C.

Next, management device 300 determines whether the amount of power supply is less than the amount of power demand of the blockchain system (S104), and when the amount of power supply is less than the amount of power demand (Yes in S104), management device 300 transmits, to power measurement terminal 200, a power-saving request to save power corresponding to the amount of power deficiency (S105). The power-saving request may include the amount of deficiency of the blockchain system or may include a target value of power consumption determined by subtracting the amount of deficiency from the current amount of power consumption.

Next, each of block generation devices A to C reports the amount of power consumption to power measurement terminal 200 (S106). Thus, power measurement terminal 200 obtains the amount of power consumption of each of block generation devices A to C that is required for the generation process.

Power measurement terminal 200 calculates a power-saving target value on the basis of the power-saving request from management device 300 and the amount of power consumption of each of block generation devices A to C that is required for the generation process (S107). The power-saving target value, which is a target value of the amount of power consumption, is a target value that can meet the power-saving request from management device 300 when the generation process is executed by consuming an amount of power that is less than or equal to the target value.

Next, power measurement terminal 200 transmits, to each of block generation devices A to C, transaction data that includes the power-saving request including the power-saving target value (S108).

Note that the processes in Steps S103, S106, and S108, which are processes to be performed for a validator node, are not performed for block generation devices that are not validator nodes.

Each of block generation devices A to C determines whether the power-saving target value can be achieved (S109). Specifically, each of block generation devices A to C determines whether block generation device 100 is capable of executing the generation process by consuming an amount of power that meets the power-saving request. For example, each of block generation devices A to C determines whether the power consumption can meet the power-saving request by reducing the amount of power consumption of the block generation process itself or cutting a process other than the block generation process. The amount of power consumption of the block generation process itself may be reduced by switching a processor assigned to execute the block generation process to a processor that is optimal in terms of power consumption, for example. For example, the processor assigned to execute the block generation process may be switched from a graphics processing unit (GPU) to a central processing unit (CPU). Cutting a process other than the block generation process is, for example, the process of switching software irrelevant to the block generation process to sleep mode or switching off the software or reducing operations of hardware in the block generation device. The hardware is a cooling fan, for example; the operations of the hardware can be reduced by controlling the cooling fan so that the number of revolutions of the fan is reduced.

When determining that the power-saving target value can be achieved (Yes in S109), each of block generation devices A to C determines whether the block generation device holds the second right (S110).

When each of block generation devices A to C determines that the block generation device holds the second right (Yes in S110), the block generation device generates and validates a block by consuming an amount of power that meets the power-saving request (S111). For example, block generation device A generates a block and transmits the generated block to block generation devices B, C. The block is connected to the blockchain after validation by block generation devices A to C. Thus, the generated block is added to the blockchain. The block to be added may include, for example, transaction data including the power-saving request or transaction data including the amount of power consumed for the generation process. In this case, the block generation device determined by lot from among block generation devices A to C performs the process of generating, for example, transaction data including the power-saving request or transaction data including the amount of power consumed for the generation process, and adding the generated transaction data to the block.

Note that block generation devices A to C may show, on the display included in management system 1, the amount of power consumed for the generation process.

Note that when determining that the power-saving target value cannot be achieved (No in S109) or when determining that the second right is not held (No in S110), each of block generation devices A to C ends the generation process.

Among block generation devices A to C, the block generation device that has generated the block obtains, from the blockchain system, a reward for generating the block (S112) when Step S111 ends. In this manner, the reward for generating the block can be obtained from the blockchain system, allowing each of block generation devices A to C to be motivated to be upgraded to a validator node. Thus, competition works to reduce the amount of power consumption of a validator node, and the adjustment of the generation process in response to the power-saving request can be more effectively made.

### Advantageous Effects, Etc.

As described above, block generation device 100 in management system 1 according to the present embodiment performs a block generation method for generating a block in the blockchain described below. Block generation device 100 obtains transaction data including a power-saving request to save power required for a generation process related to generation of a block by block generation device 100 (S108). By consuming an amount of power that meets the power-saving request, block generation device 100 executes the generation process related to generation of a block (S111).

Therefore, the generation process can be executed so as to meet the power-saving request. Thus, the amount of power consumption of the entire blockchain system can be reduced.

Furthermore, block generation device 100 in management system 1 according to the present embodiment determines whether block generation device 100 holds the first right to add a new block to the blockchain (S101). The generation process in the block generation method starts when it is determined that block generation device 100 holds the first right.

Therefore, it is possible to reduce the amount of power consumption of the block generation device that holds the first right to add a new block to the blockchain.

Furthermore, in the block generation method according to the present embodiment, the generation process starts when the generation process is executable by consuming an amount of power that meets the power-saving request.

Therefore, the block generation device capable of executing the generation process by consuming an amount of power that meets the power-saving request can add a new block to the blockchain. Thus, the block generation device capable of reducing power consumption executes the generation process and therefore, the amount of power consumption of the entire blockchain system can be effectively reduced.

Furthermore, in the block generation method according to the present embodiment, the determining further includes: (i) calculating, based on the power-saving request, a target value of the amount of power consumption required for the generation process and an expected amount of power consumption which is an amount of power consumption expected to be required for the generation process; and (ii) when the expected amount of power consumption is less than or equal to the target value, determining that the generation process is executable by consuming an amount of power that meets the power-saving request.

Therefore, a block generation device capable of setting the expected amount of power consumption, which is an amount of power consumption expected to be required for the generation process, to less than or equal to the target value of power consumption can add a new block to the blockchain. Thus, the block generation device capable of reducing power consumption executes the generation process and therefore, the amount of power consumption of the entire blockchain system can be effectively reduced.

Furthermore, in the block generation method according to the present embodiment, in the determining, when the generation process is executable by consuming an amount of power that meets the power-saving request, block generation device 100 further determines whether block generation device 100 holds the second right to add a new block to the blockchain (S110). The generation process starts when it is determined that block generation device 100 holds the first right and the second right and the generation process is executable by consuming an amount of power that meets the power-saving request.

Therefore, it is possible to reduce the amount of power consumption of the block generation device that further holds the second right to add a new block to the blockchain.

Furthermore, in the block generation method according to the present embodiment, block generation device 100 that holds the second right holds the first right and is selected at random from among one or more block generation devices 100 capable of executing the generation process by consuming an amount of power that meets the power-saving request.

Therefore, when there are one or more block generation devices 100 capable of executing the generation process by consuming an amount of power that meets the power-saving request, block generation device 100 capable of adding a new block to the blockchain can be determined.

### Variation of Embodiment 1

The determination of a validator node that generates and validates a block is made by each of block generation devices A to C in Embodiment 1 described above, but may be made by power measurement terminal 200.

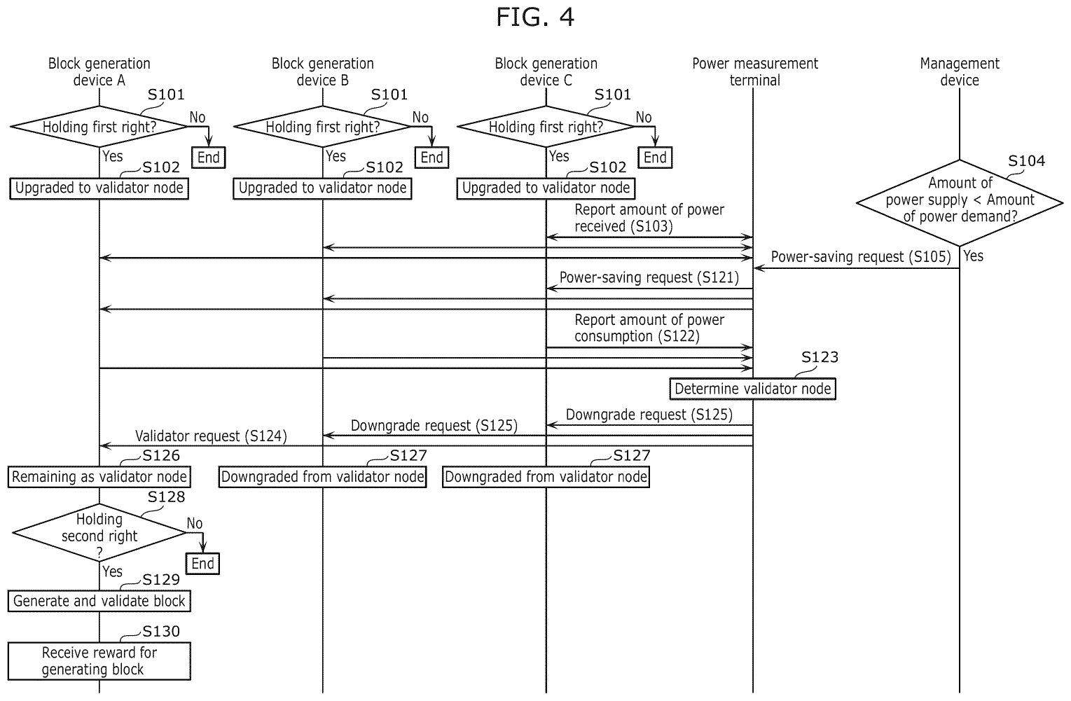

FIG. 4 is a sequence chart for describing one example of a generation process executed in response to a power-saving request, in a management system according to a variation of Embodiment 1.

Step S101 to Step S105 are substantially the same as those in the sequence chart according to Embodiment 1 and therefore, description thereof will be omitted.

When receiving a power-saving request from management device 300, power measurement terminal 200 transmits, to each of block generation devices A to C, transaction data including a power-saving request based on the power-saving request received (S121). This transaction data is the same as the transaction data described as being transmitted in Step S108.

When receiving the power-saving request from power measurement terminal 200, each of block generation devices A to C reports, to power measurement terminal 200, an amount of power consumption required for the generation process (S122). This process is the same as that in Step S106.

Power measurement terminal 200 compares the amount of power consumption of each of block generation devices A to C and the target value included in the power-saving request, thereby determining a validator node from among block generation devices A to C (S123). The following will describe the case where block generation device A is determined as a validator node and block generation devices B, C are not determined as validator nodes.

Power measurement terminal 200 transmits, to block generation device A determined as a validator node, a validator request for requesting to hold rights as a validator node (S124), and transmits, to each of block generation devices B, C not determined as a validator node, a downgrade request for requesting not to hold rights as a validator node (to be downgraded from a validator node) (S125).

Block generation device A that has received the validator request keeps the rights as a validator node (S126), and each of block generation devices B, C that has received the downgrade request is downgraded from a validator node and becomes a node that does not hold rights as a validator node (S127).

Block generation device A determines whether block generation device A holds the second right (S128).

When determining that block generation device A holds the second right (Yes in S128), block generation device A generates and validates a block (S129). Thus, the generated block is added to the blockchain. The block to be added may include transaction data including the power-saving request or transaction data including the amount of power consumed for the generation process.

Note that when determining that block generation device A does not hold the second right (No in S128), block generation device A ends the generation process.

When Step S129 ends, block generation device A obtains, from the blockchain system, a reward for generating the block (S130). In this manner, the reward for generating the block can be obtained from the blockchain system, allowing each of block generation devices A to C to be motivated to be upgraded to a validator node. Thus, competition works to reduce the amount of power consumption of a validator node, and the adjustment of the generation process in response to the power-saving request can be more effectively made.

### Embodiment 2

While block generation devices A to C execute the generation process using PoS in Embodiment 1, block generation devices A to C execute the generation process using POW in Embodiment 2. The following will describe an example where the generation process is executed using PoW.

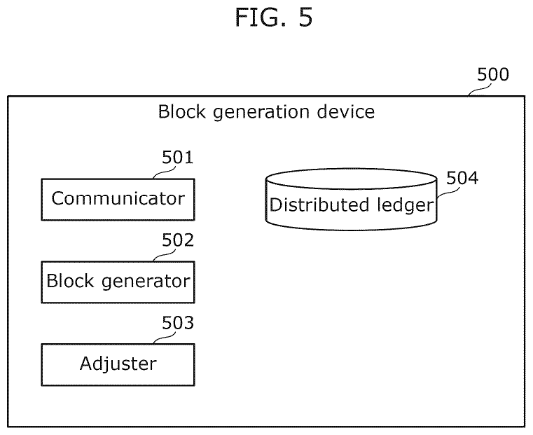

FIG. 5 is a diagram illustrating one example of the configuration of a block generation device according to Embodiment 2.

Block generation device 500 has the function of generating a block in a blockchain. As illustrated in FIG. 5, block generation device 500 includes communicator 501, block generator 502, adjuster 503, and distributed ledger 504. Block generation device 500 can be implemented by a processor executing a predetermined program using a memory. Block generation device 500 is used instead of block generation device 100 according to Embodiment 1. The structural elements will be described below.

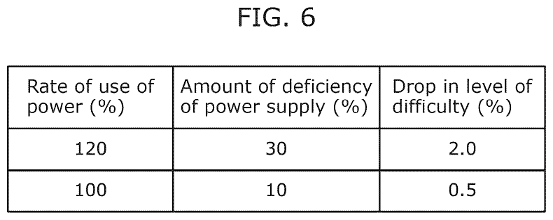

Communicator 501 transfers data to and from power measurement terminal 200. For example, communicator 501 transmits, to power measurement terminal 200, the amount of power received by block generation device 500. Furthermore, communicator 501 obtains, from power measurement terminal 200, transaction data including a power-saving request to save power required for a generation process related to generation of a block by block generation device 500. The transaction data may include difficulty level information (refer to FIG. 6) indicating the relationship between the power-saving request and the level of difficulty of mining. Moreover, communicator 501 transmits, to power measurement terminal 200, the amount of power consumption of block generation device 500.

Furthermore, communicator 501 may transfer data to and from other block generation devices 500. For example, communicator 501 transmits and receives one or more items of transaction data to and from other block generation devices 500 according to a consensus algorithm. Moreover, communicator 501 may transfer data to and from a device (terminal) different from power measurement terminal 200 and other block generation devices 500.

In this manner, communicator 501 performs communication with power measurement terminal 200 and other block generation devices 500. Note that this communication may be performed using transport layer security (TLS) and a cryptographic key for TLS communication may be held in communicator 501.

Block generator 502 executes a generation process related to generation of a block in a blockchain. When communicator 501 receives a power-saving request, block generator 502 attempts to execute the generation process by consuming the amount of power consumption that meets the power-saving request.

Specifically, block generator 502 executes the generation process using PoW. The generation process is, for example, the entire process from generating a block in a blockchain to adding the block to the blockchain or a part of said process. PoW is an algorithm in which nodes (computers) in a blockchain network competitively solve a problem and thereby provides proof in order to generate a new block on a distributed ledger. Specifically, in order to generate a new block, the nodes in the network input a predetermine number of nonces and execute a hash function using the values of the nonces. At this time, mining is conducted in which trial and error are repeated until a hash value becomes less than a threshold value corresponding to the level of difficulty (the level of difficulty of mining). A node that has conducted the mining and found the hash value corresponding to the level of difficulty obtains the right to generate a new block. The level of difficulty of mining is adjusted by adjuster 503 to be described later, and block generator 502 executes the generation process on the basis of the level of difficulty of mining that has been adjusted.

Adjuster 503 adjusts the level of difficulty of mining on the basis of the power-saving request. Specifically, adjuster 503 adjusts the level of difficulty of mining on the basis of the power-saving request and the difficulty level information.

FIG. 6 is a table illustrating one example of the difficulty level information. Management system 1 may include a display and may show the difficulty level information on the display.

The difficulty level information is information in which the rate of use of power, the amount of deficiency of power supply, and the drop in the level of difficulty are associated with each other. The difficulty level information does not need to include the rate of use of power. The amount of deficiency of power supply is a ratio (percentage) of deficiency, which is calculated by subtracting the amount of power supply from the amount of power demand, relative to the amount of power supply, for example. When the amount of deficiency of power supply is 30%, the drop in the level of difficulty can be calculated as 2.0%. The drop in the level of difficulty is a drop from the current level of difficulty where the current level of difficulty is 100%; when the drop in the level of difficulty is 2.0%, the level of difficulty after adjustment is 98% of the current level of difficulty. When the amount of deficiency of power supply is 10%, the drop in the level of difficulty can be calculated as 0.5%.

In this manner, adjuster 503 adjusts the level of difficulty of mining on the basis of the drop in the level of difficulty that is associated with the amount of deficiency of power supply, which is the amount of deficiency included in the power-saving request, in the difficulty level information.

Furthermore, adjuster 503 may adjust the level of difficulty of mining so that the level of difficulty of mining is reduced with an increase in the amount of deficiency of power supply to a region in which block generation device 500 is located. This is because the amount of power consumption required for mining is reduced as the level of difficulty of mining is reduced.

Furthermore, the difficulty level information may indicate a drop in the level of difficulty of mining when there is a deficiency of power supply to a region in which block generation device 500 is located while indicating a rise in the level of difficulty of mining when there is no deficiency of power supply to said region.

The blockchain is stored on distributed ledger 504.

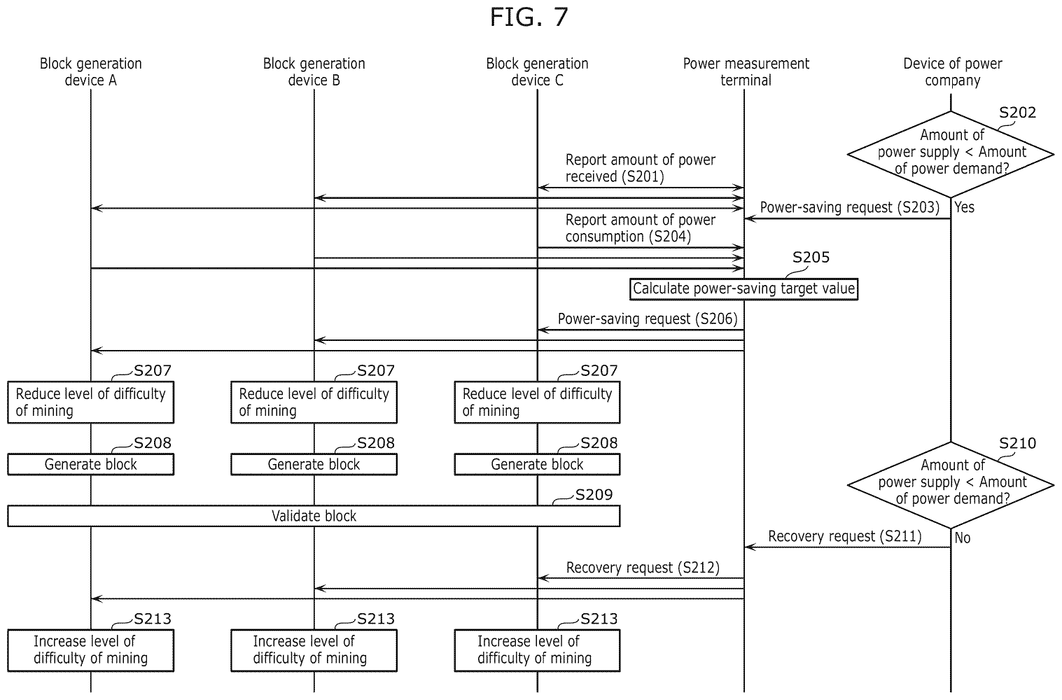

FIG. 7 is a sequence chart for describing one example of the generation process executed in response to the power-saving request, in the management system according to Embodiment 2.

Each of block generation devices A to C establishes communication with power measurement terminal 200 and reports, to power measurement terminal 200, the amount of power received by the block generation device (S201).

Next, management device 300 determines whether the amount of power supply is less than the amount of power demand of the blockchain system (S202), and when the amount of power supply is less than the amount of power demand (Yes in S202), management device 300 transmits, to power measurement terminal 200, a power-saving request to save power corresponding to the amount of power deficiency (S203). The power-saving request may include the amount of deficiency of the blockchain system or may include a target value of power consumption determined by subtracting the amount of deficiency from the current amount of power consumption.

Next, each of block generation devices A to C reports the amount of power consumption to power measurement terminal 200 (S204). Thus, power measurement terminal 200 obtains the amount of power consumption of each of block generation devices A to C that is required for the generation process.

Power measurement terminal 200 calculates a power-saving target value on the basis of the power-saving request from management device 300 and the amount of power consumption of each of block generation devices A to C that is required for the generation process (S205). The power-saving target value, which is a target value of power consumption, is a target value that can meet the power-saving request from management device 300 when the generation process is executed by consuming an amount of power that is less than or equal to the target value.

Next, power measurement terminal 200 transmits, to each of block generation devices A to C, transaction data that includes the power-saving request including the power-saving target value (S206).

Each of block generation devices A to C reduces the level of difficulty of mining in response to the power-saving request (S207).

Each of block generation devices A to C conducts mining at the reduced level of difficulty and generates a block (S208). Note that each of block generation devices A to C may cause the display included in management system 1 to show at least one of the current level of difficulty of mining, a rise or drop in the level of difficulty of mining, and the level of difficulty of mining applied during generation of the block.

Each of block generation devices A to C validates the generated block and adds the validated block to the blockchain on distributed ledger 104 held by the block generation device (S209).

Next, management device 300 determines whether the amount of power supply is less than the amount of power demand of the blockchain system (S210), and when the amount of power supply is greater than or equal to than the amount of power demand (No in S210), management device 300 transmits, to power measurement terminal 200, a recovery request for undoing the power-saving request (S211). The recovery request includes a request to stop the process of reducing the amount of power consumption in response to the power-saving request and then perform the original process.

Next, power measurement terminal 200 transmits, to each of block generation devices A to C, transaction data that includes the recovery request (S212).

Each of block generation devices A to C increases the level of difficulty of mining in response to the recovery request (S213). Specifically, the level of difficulty of mining is returned to the former level of difficulty applied before the level of difficulty is reduced in response to the power-saving request. Subsequently, each of block generation devices A to C conducts mining at the increased level of difficulty, generates a block, and validates the generated block.

### Advantageous Effects, Etc.

In the block generation method performed by block generation device 500 according to the present embodiment, the level of difficulty of mining is adjusted on the basis of the power-saving request (S207). The generation process is executed on the basis of the level of difficulty of mining that has been adjusted.

As the level of difficulty of mining is reduced, processing load required for mining is reduced and thus, the amount of power consumption required for mining is also reduced. Therefore, the amount of power consumption required for the generation process can be adjusted by adjusting the level of difficulty of mining in response to the power-saving request.

Furthermore, in the block generation method according to the present embodiment, the transaction data further includes the difficulty level information indicating the relationship between the power-saving request and the level of difficulty of mining. In the adjustment of the level of difficulty of mining, the level of difficulty of mining is adjusted on the basis of the power-saving request and the difficulty level information.

Therefore, the level of difficulty of mining corresponding to the power-saving request can be properly determined on the basis of the difficulty level information and thus, the amount of power consumption required for the generation process can be reduced in response to the power-saving request.

Furthermore, in the block generation method according to the present embodiment, in the adjustment of the level of difficulty of mining, the level of difficulty is adjusted so that the level of difficulty of mining is reduced with an increase in the amount of deficiency of power supply to a region in which each of block generation devices A to C is located.

Therefore, the amount of power consumption of each of block generation devices A to C can be reduced according to the amount of deficiency of power supply to a region in which said one of block generation devices A to C is located.

Furthermore, in the block generation method according to the present embodiment, the difficulty level information indicates a drop in the level of difficulty of mining when there is a deficiency of power supply to a region in which each of block generation devices A to C is located while indicating a rise in the level of difficulty of mining when there is no deficiency of power supply.

Therefore, the amount of power consumption of each of block generation devices A to C can be adjusted according to whether there is a deficiency of power supply to a region in which said one of block generation devices A to C is located.

### Variation of Embodiment 2

In Embodiment 2, the level of difficulty of mining is determined by each of block generation devices A to C, but this is not limiting; the level of difficulty of mining may be determined by power measurement terminal 200. The level of difficulty of mining determined by power measurement terminal 200 may be reported to each of block generation devices A to C, and each of block generation devices A to C may execute the block generation process according to the level of difficulty of mining reported by power measurement terminal 200.

### Other Embodiments

In Embodiments 1 and 2 described above, power measurement terminal 200 and management device 300 transfer information therebetween, but this is not limiting.

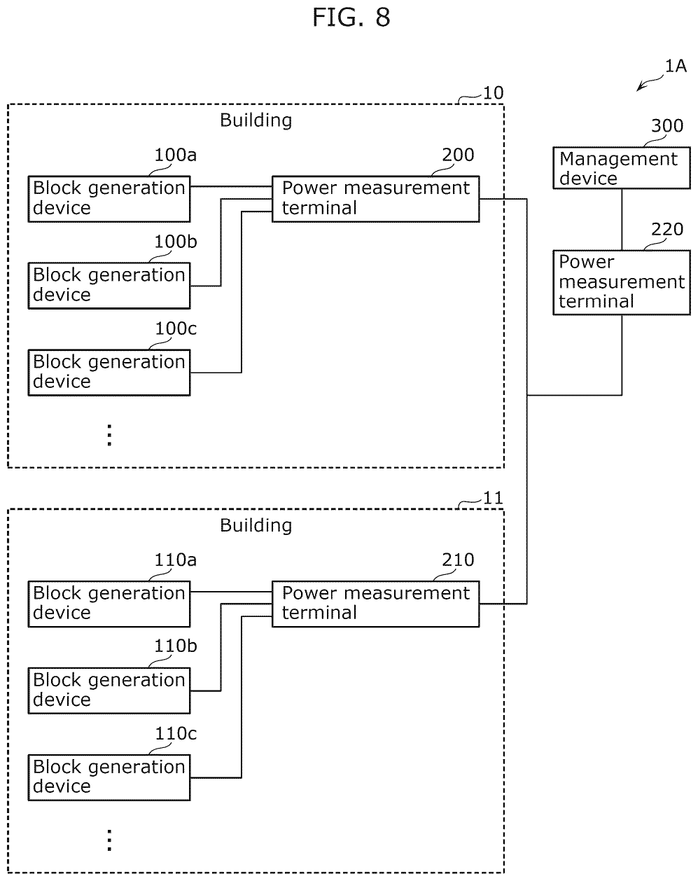

FIG. 8 is a diagram illustrating one example of the configuration of a management system according to another embodiment.

As illustrated in FIG. 8, management system 1A may include, in addition to block generation devices 100a to 100c and power measurement terminal 200 which are included in building 10, block generation devices 110a to 110c and power measurement terminal 210 which are included in building 11. Management system 1A may further include power measurement terminal 220 which is connected to power measurement terminals 200, 210.

Block generation devices 110a to 110c and power measurement terminal 210 have substantially the same functions as block generation devices 100a to 100c and power measurement terminal 200, respectively.

Power measurement terminal 220 obtains information related to power consumption of block generation devices 100a to 100c, 110a to 110c from power measurement terminals 200, 210. Furthermore, power measurement terminal 220 may receive power-saving requests from management device 300, transmit the power-saving request for building 10 to power measurement terminal 200, and transmit the power-saving request for building 11 to power measurement terminal 210.

### Other Embodiments

In the method according to the embodiments described above, the information obtained, generated, and output by management system 1 or management system 1A may be stored on the blockchain.

The method according to the embodiments described above may be realized using a smart contract. By executing the smart contract, a predetermined program is automatically executed without intervention of other people or other systems. Thus, the smart contract allows a series of processes to be implemented more securely.

### Additional Comments

The following are additional comments on the blockchain according to the embodiments described above.

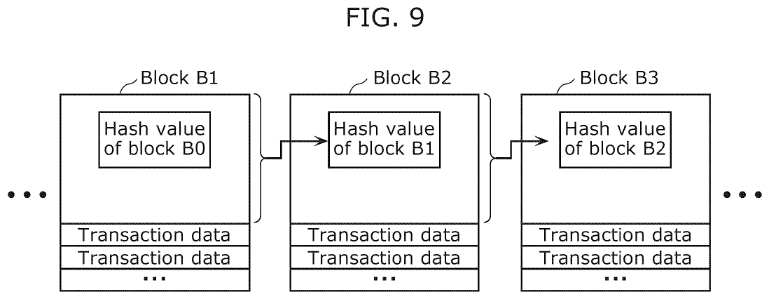

FIG. 9 is an explanatory diagram illustrating the data structure of the blockchain.

The blockchain is made up of blocks, each of which is a recording unit of the blockchain, linked together in the form of a chain. Each of the blocks includes a plurality of items of transaction data and a hash value of an immediately preceding block. Specifically, block B2 includes the hash value of previous block B1. Furthermore, a hash value calculated using the hash value of block B1 and the plurality of items of transaction data included in block B2 is included in block B3 as the hash value of block B2. In this manner, blocks are linked together in the form of a chain while including the content of previous blocks; thus, the recorded transaction data is effectively prevented from being tempered with.

If previous transaction data is changed, the hash value of the block becomes different from the original value, meaning that in order to make the block tampered with look correct, all the subsequent blocks need to be recreated, which is an extremely difficult task in practice. Using this feature, it is ensured that the blockchain is tamper-proof.

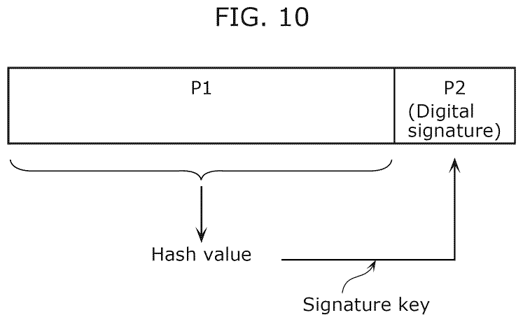

FIG. 10 is an explanatory diagram illustrating the data structure of the transaction data.

The transaction data illustrated in FIG. 10 includes transaction body P1 and digital signature P2. Transaction body P1 is a data body included in said transaction data. Digital signature P2 is generated for the hash value of transaction body P1 by using a signature key of a creator of said transaction data; more specifically, digital signature P2 is generated by encrypting said hash value with a private key of the creator of said transaction data. As a means of implementing the digital signature, the elliptic curve digital signature algorithm (ECDSA), CRYSTALS-DILITHIUM, FALCON, SPHINCS+, or the like may be used.

Because of including digital signature P2, the transaction data is virtually impossible to tamper with. This is because tampering with the transaction data will result in unsuccessful verification using digital signature P2, which reveals that the transaction data has been tampered with. Thus, transaction body P1 is protected from tampering.

### Other Embodiments, Etc.

The present disclosure has been described thus far based on the above embodiments, but it goes without saying that the present disclosure is not limited to the above embodiments. The following examples are also intended to be included within the scope of the present disclosure.

(1) Each of the devices according to the above embodiments is specifically a computer system configured from a microprocessor, a read-only memory (ROM), a random-access memory (RAM), a hard disk unit, a display unit, a keyboard, and a mouse, for example. A computer program is recorded in the RAM or the hard disk unit. Each of the devices achieves its function as a result of the microprocessor operating according to the computer program. Here, the computer program is configured of a combination of command codes indicating instructions to the computer in order to achieve a predetermined function.

(2) Some or all of the structural elements included in each of the devices according to the above embodiments may be configured from a single system Large Scale Integration (LSI). A system LSI is a super-multifunctional LSI manufactured with a plurality of components integrated on a single chip, and is specifically a computer system configured of a microprocessor, a ROM, and a RAM, for example. A computer program is recorded in the RAM. The system LSI achieves its function as a result of the microprocessor operating according to the computer program.

Furthermore, each unit of the structural elements included in each of the devices described above may be individually configured into a single chip, or some or all of the units may be configured into a single chip.

Moreover, although a system LSI is mentioned here, the integrated circuit can also be called an IC, a LSI, a super LSI, and an ultra LSI, depending on the level of integration. Furthermore, the method of circuit integration is not limited to LSI, and implementation through a dedicated circuit or a general-purpose processor is also possible. A field programmable gate array (FPGA) which allows programming after LSI manufacturing or a reconfigurable processor which allows reconfiguration of the connections and settings of the circuit cells inside the LSI may also be used.

In addition, depending on the emergence of circuit integration technology that replaces LSI due to progress in semiconductor technology or other derivative technology, it is obvious that such technology may be used to integrate the function blocks. Possibilities in this regard include the application of biotechnology and the like.

(3) Some or all of the structural elements included in each of the devices described above may be implemented as a standalone module or an IC card that can be inserted into and removed from the device. The IC card or the module is a computer system made up of a microprocessor, a ROM, a RAM, and so on. The IC card or the module may include the aforementioned super-multifunctional LSI. The IC card or the module achieves its functions as a result of the microprocessor operating according to the computer program. The IC card and the module may be tamper-proof.

(4) The present disclosure may be the above-described methods. Furthermore, the present disclosure may be a computer program for implementing these methods using a computer or may be a digital signal of the computer program.

Furthermore, the present disclosure may be the computer program or the digital signal recorded on recording media readable by a computer, such as a flexible disk, a hard disk, a CD-ROM, a magneto-optical disc (MO), a digital versatile disc (DVD), a DVD-ROM, a DVD-RAM, a Blu-ray (registered trademark) disc (BD), or a semiconductor memory, for example. The present disclosure may also be the digital signal recorded on these recoding media.

Furthermore, in the present disclosure, the computer program or the digital signal may be transmitted via an electrical communication line, a wireless or wired communication line, a network represented by the Internet, data broadcasting, or the like.

Furthermore, the present disclosure may be a computer system including a microprocessor and memory. The memory may have the computer program recorded thereon, and the microprocessor may operate according to the computer program.

Moreover, by transferring the recording medium having the program or the digital signal recorded thereon or by transferring the program or the digital signal via the network or the like, the present disclosure may be implemented by a different independent computer system.

(5) The above embodiments and the above variations may be combined with each other.

### INDUSTRIAL APPLICABILITY

The present disclosure can be used for a block generation method, etc.; for example, the present disclosure is usable for a block generation method, etc., in which the amount of power consumption required for the process of adding a block to a blockchain can be adjusted in response to a power-saving request.

1. A block generation method performed by a block generation device that generates a block in a blockchain, the block generation method comprising:
obtaining transaction data including a power-saving request to save power required for a generation process related to generation of the block by the block generation device; and
executing the generation process by consuming an amount of power that meets the power-saving request.

2. The block generation method according to claim 1, further comprising:
determining whether the block generation device holds a first right to add a new block to the blockchain, wherein
the generation process starts when the block generation device is determined as holding the first right.

3. The block generation method according to claim 2, wherein
the generation process starts when the generation process is executable by consuming the amount of power.

4. The block generation method according to claim 3, wherein
the determining further includes: (i) calculating, based on the power-saving request, a target value of an amount of power consumption required for the generation process and an expected amount of power consumption which is an amount of power consumption expected to be required for the generation process; and (ii) when the expected amount of power consumption is less than or equal to the target value, determining that the generation process is executable by consuming the amount of power.

5. The block generation method according to claim 2, wherein
the determining further includes: when the generation process is executable by consuming the amount of power, determining whether the block generation device holds a second right to add a new block to the blockchain, and
the generation process starts when the block generation device is determined as holding the first right and the second right and the generation process is executable by consuming the amount of power.

6. The block generation method according to claim 5, wherein
the block generation device that holds the second right is determined at random from among one or more block generation devices each holding the first right and capable of executing the generation process by consuming the amount of power.

7. The block generation method according to claim 1, further comprising:
adjusting a level of difficulty of mining based on the power-saving request, wherein
the generation process is executed based on the level of difficulty of mining that has been adjusted.

8. The block generation method according to claim 7, wherein
the transaction data further includes difficulty level information indicating a relationship between the power-saving request and the level of difficulty of mining, and
in the adjusting, the level of difficulty of mining is adjusted based on the power-saving request and the difficulty level information.

9. The block generation method according to claim 8, wherein
in the adjusting, the level of difficulty is adjusted to be reduced with an increase in an amount of deficiency of power supply to a region in which the block generation device is located.

10. The block generation method according to claim 8, wherein
the difficult level information indicates a drop in the level of difficulty of mining when power supply to a region in which the block generation device is located is deficient, and indicates a rise in the level of difficulty of mining when the power supply is not deficient.

11. A block generation device that generates a block in a blockchain, the block generation device comprising:
an obtainer that obtains transaction data including a power-saving request to save power required for a generation process related to generation of the block by the block generation device; and
a block generator that executes the generation process by consuming an amount of power that meets the power-saving request.

12. A non-transitory computer-readable recording medium having stored therein a program for causing a computer to perform the block generation method according to claim 1.
